(19) United States
(12) Patent Application Publication
(10) Pub. No.: US 2026/0008302 A1
(43) Pub. Date: Jan. 8, 2026

(54) STROLLER HANDLEBAR ACTUATOR

(71) Applicant: Graco Children's Products Inc., Atlanta, GA (US)

(72) Inventors: Andrew Q. Liu, Sandy Springs, GA (US); Matthew A. Johnson, South Haven, MI (US); Darren Zhen Kit Tan, Marietta, GA (US)

(21) Appl. No.: 19/262,046

(22) Filed: Jul. 7, 2025

Related U.S. Application Data
(60) Provisional application No. 63/668,413, filed on Jul. 8, 2024.
(60) Provisional application No. 63/699,040, filed on Sep. 25, 2024.

(51) Int. Cl. B60B 33/02; B62B 7/04; B62B 9/20

(52) U.S. Cl. CPC B60B 33/026; B62B 7/04; B62B 9/20; B62B 2301/046

(57) ABSTRACT

A stroller handlebar actuator is provided. The handlebar actuator is provided at a handlebar of the stroller and includes cables that are attached to the handlebar actuator at one end and rear wheels of the stroller at another end. The handlebar actuator includes a protruding tab that a user to able to press using one or both thumbs without needing to remove their hands from the outer ends of the handlebar. By pressing the tab, a rotational force is exerted on the handlebar actuator, causing the handlebar actuator to rotate relative to the handlebar. This rotation causes the cables to pull inwards towards the handlebar actuator, thereby unlocking mechanisms provided at the rear wheels. The unlocking of the mechanisms causes the rear wheels to be able to freely rotate about a vertical axis. When the force is removed from the handlebar actuator, the handlebar actuator rotates back to its natural resting position and the cables return back to their original positions, locking the rear wheels.

### CROSS-REFERENCE TO RELATED APPLICATIONS

This application claims priority to and benefit of U.S. provisional patent application No. 63/668,413 filed Jul. 8, 2024 and U.S. provisional patent application No. 63/699,040 filed Sep. 25, 2024, both of which are herein incorporated by reference.

### TECHNICAL FIELD

The present disclosure is generally in the field of strollers, and more particularly related to handlebar actuators for strollers.

### BACKGROUND

Some strollers may include mechanisms provided at the rear wheels that allow the rear wheels to transition from a “drift” mode in which the rear wheels are able to freely rotate about a vertical axis and a locked mode in which the rear wheels remain locked in the same orientation. The drift mode may be preferable in some scenarios where it is desired to more easily turn the stroller and the locked mode may be preferable in scenarios where it is desired to push the stroller in a straight line while keeping the wheels locked and in a more stable configuration. Conventionally, the mechanisms at the wheels are actuated by squeezing a handlebar actuator provided in a center location of the handlebar of the stroller. However, to squeeze the handlebar actuator, a user is required to have a threshold amount of grip strength, which may be difficult for some users, such as elderly or injured users. Additionally, the user is required to move one hand towards the center of the handlebar where the handlebar actuator is located. The user being forced to move one hand towards the center of the handlebar may result in less ideal hand positioning for continuing to push the stroller. The user may need to stop pushing the stroller to squeeze the mechanism, depending on how comfortable the user is with continuing to push the stroller with the temporarily adjusted hand positions.

### SUMMARY

In embodiments, the present disclosure describes a handlebar actuator. The handlebar actuator comprises an external housing including a protruding tab, an inner core comprising an opening, one or more first rails, and one or more second rails, a first slider disposed in the opening and configured to translate along the one or more first rails based on a rotation of the external housing, and a second slider disposed in the opening and configured to translate along the one or more second rails based on the rotation of the external housing.

In embodiments, the present disclosure describes a stroller. The stroller comprises a handlebar and a handlebar actuator. The handlebar actuator comprises an external housing including a protruding tab, an inner core comprising an opening, one or more first rails, and one or more second rails, a first slider disposed in the opening and configured to translate along the one or more first rails based on a rotation of the external housing, and a second slider disposed in the opening and configured to translate along the one or more second rails based on the rotation of the external housing.

In embodiments, the present disclosure describes a stroller. The stroller comprises a handlebar, a first wheel and a second wheel, and a handlebar actuator. The handlebar actuator comprises an external housing including a protruding tab, an inner core comprising an opening, one or more first rails, and one or more second rails, a first slider disposed in the opening and configured to translate along the one or more first rails based on a rotation of the external housing, a second slider disposed in the opening and configured to translate along the one or more second rails based on the rotation of the external housing, a first cable connected to the first slider at a first end and the first wheel at a second end and a second cable connected to the second slider at a first end and the second wheel at a second end. The external housing is configured to rotate about the inner core based on a force against the protruding tab, wherein rotation of the external housing causes the first cable and second cable to pull inwards on the first slider and the second slider and unlock a first mechanism at the first wheel and a second mechanism at the second wheel to allow the first wheel and second wheel to freely rotate.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A shows a stroller including the handlebar actuator, in accordance with one or more embodiments of the disclosure.

FIGS. 1B-1E illustrate actuation of the handlebar actuator of the stroller of FIG. 1A, in accordance with one or more embodiments of the disclosure.

FIG. 2 shows a close-up view of the handlebar actuator, in accordance with one or more embodiments of the disclosure.

FIG. 3 shows an exploded view of the handlebar actuator of FIG. 2, in accordance with one or more embodiments of the disclosure.

FIG. 4A shows a side view of the handlebar actuator of FIG. 2 in a first rotated position, in accordance with one or more embodiments of the disclosure.

FIG. 4B shows a side view of the handlebar actuator of FIG. 4A in a second rotated position, in accordance with one or more embodiments of the disclosure.

FIG. 5A shows a front view of the handlebar actuator of FIG. 4A in the first rotated position, in accordance with one or more embodiments of the disclosure.

FIG. 5B shows a front view of the handlebar actuator of FIG. 4B in the second rotated position, in accordance with one or more embodiments of the disclosure.

FIG. 6A shows another front view of the handlebar actuator of FIG. 5A in the first rotated position, in accordance with one or more embodiments of the disclosure.

FIG. 6B shows another front view of the handlebar actuator of FIG. 5B in the second rotated position, in accordance with one or more embodiments of the disclosure.

FIG. 7 shows a perspective view of an outer cover of the handlebar actuator of FIG. 2, in accordance with one or more embodiments of the disclosure.

FIG. 8 shows a perspective view of a rotational sleeve and inner core of the handlebar actuator of FIG. 2, in accordance with one or more embodiments of the disclosure.

FIG. 9 shows a wheel locking mechanism of the stroller of FIG. 1, in accordance with one or more embodiments of the disclosure.

FIG. 10A shows an exploded front view of another handlebar actuator, in accordance with one or more embodiments of the disclosure.

FIGS. 10B-10C shows an exploded perspective view of the handlebar actuator of FIG. 10A, in accordance with one or more embodiments of the disclosure.

FIG. 11A shows a side view of the handlebar actuator of FIG. 10A in a first rotated position, in accordance with one or more embodiments of the disclosure.

FIG. 11B shows a side view of the handlebar actuator of FIG. 11A in a second rotated position, in accordance with one or more embodiments of the disclosure.

FIG. 12A shows a front view of the handlebar actuator of FIG. 10A in a first rotated position, in accordance with one or more embodiments of the disclosure.

FIG. 12B shows a front view of the handlebar actuator of FIG. 10A in a second rotated position, in accordance with one or more embodiments of the disclosure.

FIG. 12C shows the front view of FIG. 12A with a translucent external housing, in accordance with one or more embodiments of the disclosure.

FIG. 12D shows the front view of FIG. 12D with a translucent external housing, in accordance with one or more embodiments of the disclosure.

FIGS. 13A-13B show exemplary cable configurations, in accordance with one or more embodiments of the disclosure.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

The present disclosure describes variations of stroller handlebar actuators. Conventional stroller handlebar actuators include a mechanism that is actuated based on a user squeezing the handlebar actuator with their hand. Actuation of the mechanism causes the rear wheel of the stroller to transition between a “drift” mode (in which the rear wheels of the stroller can rotate freely about a vertical axis) and a locked mode (in which the same wheels are locked and unable to freely rotate). However, the squeeze-based mechanism may be more difficult for some users to actuate. For example, the squeeze-based mechanism may require a threshold amount of hand strength. Furthermore, the squeeze-based mechanism may also require at least one hand of the user to be moved to the central location of the handlebar where the actuator is positioned. The most stable positioning of the user's hands for pushing the stroller may include each hand being positioned on either end of the handlebar (on either side of the center where the handlebar actuator is located). Accordingly, requiring the user to move one hand away from the end of the handlebar towards the center of the handlebar to squeeze the handlebar actuator results in one hand of the user moving to an unideal position if the user is still pushing the stroller.

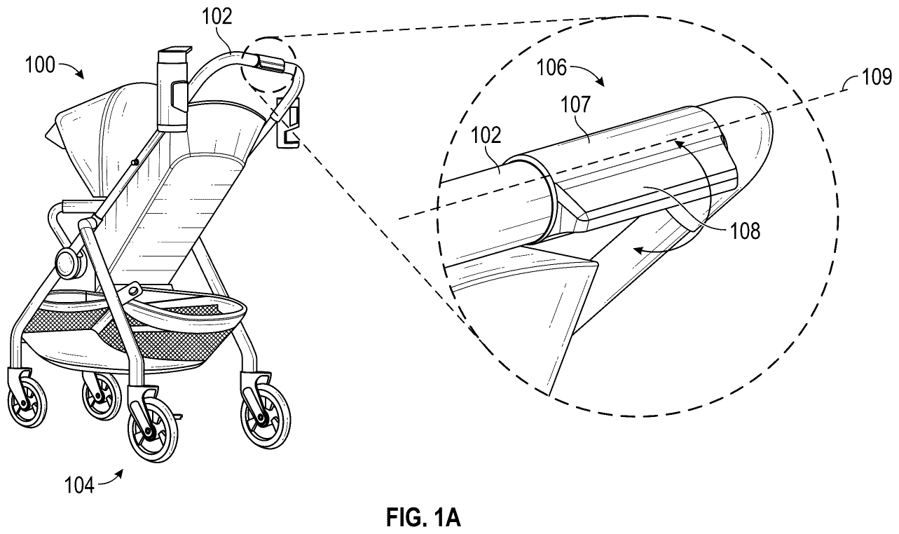

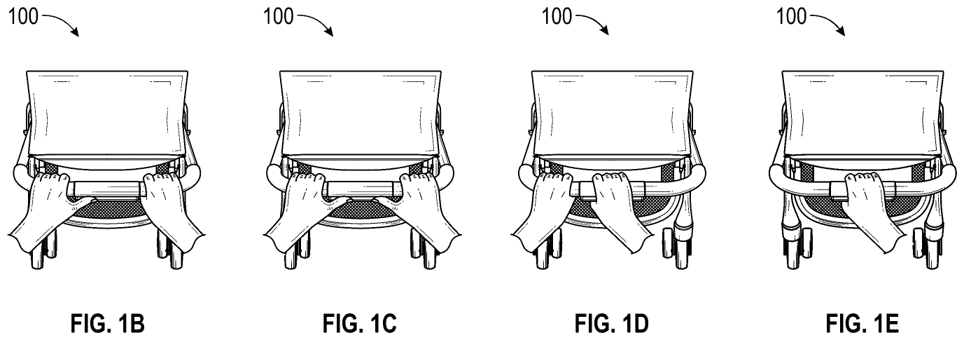

In contrast, the improved stroller handlebar actuator described herein includes a different mechanism for transitioning the wheels between the drift mode and the locked mode. Particularly, the mechanism is actuated by rotating an external housing relative to the handlebar (shown in more detail in FIG. 1A). The external housing includes a protruding tab that may be pressed with a minimal amount of force to cause this rotation. The protruding tab allows for the handlebar actuator to be more easily actuated than the conventional handlebar actuator because the user only needs to apply a small amount of force to the protruding tab to cause the rotation. For example, the user may cause rotation of the handlebar actuator by pressing on the protruding tab using one or both of their thumbs while maintaining hand positioning on either end of the handlebar. Accordingly, the user can actuate the handlebar actuator while continuing to push the stroller with both hands maintained in the ideal pushing position (on either end of the handlebar).

In some embodiments (for example, shown in FIGS. 1A-8), the handlebar actuator includes an inner core (provided within the external housing) that includes two horizontal slots housing two springs, with each of the springs being connected to a pin. The springs are biased such that, in their resting state, they naturally press the pins outwards away from the center of the inner core. The pins are, in turn, each connected to a cable. The handlebar actuator also includes a rotational sleeve with slanted grooves that are provided around the inner core and within the external housing. The rotational sleeve also includes two slots in which the pins are also provided, however, the slots on the rotational sleeve curve inwards along the rotational sleeve.

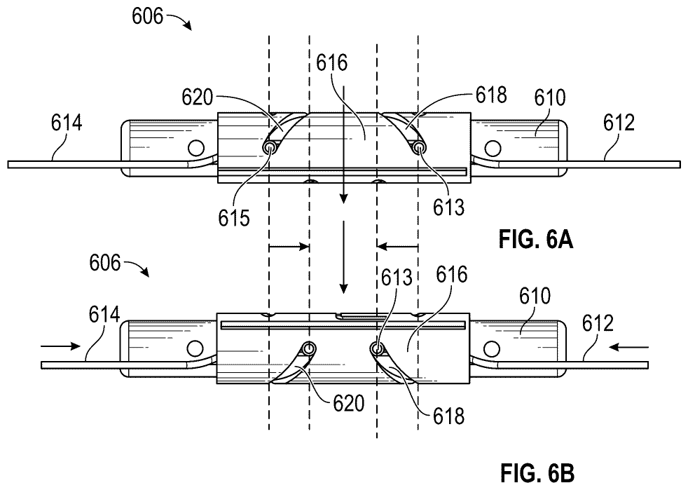

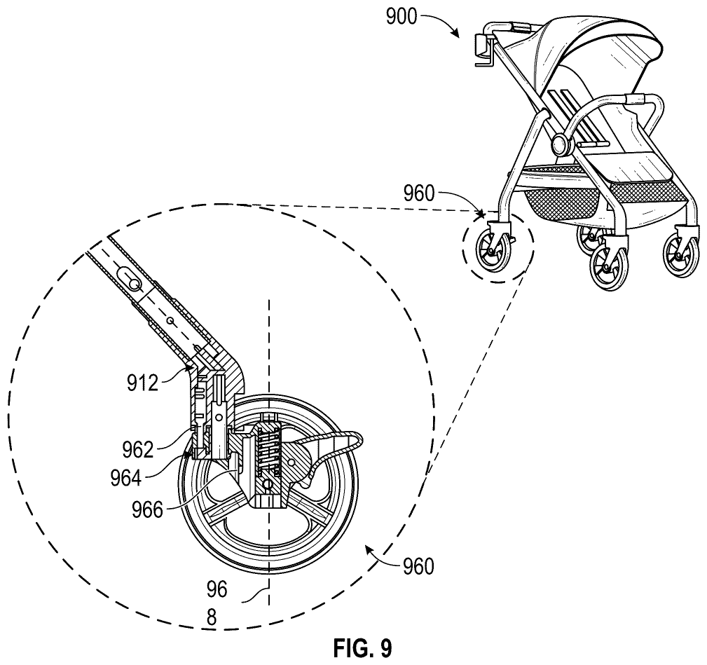

When the handlebar actuator is rotated, the pins travel through the slots of the rotational sleeve inwards towards the center of the rotational sleeve, causing the pins to press against the springs in the horizontal slots of the inner core and pull the cables inward (this is further illustrated in FIGS. 6A-6B). The cables being pulled inward cause mechanisms within the rear wheels to actuate to transition the rear wheels between the drift mode and the locked mode (or vice versa). This is shown in further detail in FIG. 9.

Likewise, when the force is removed from the protruding tab (for example, the user ceases pressing on the protruding tab with their thumb(s)) and the handlebar actuator rotated back to its resting position, the springs force the pins back outward, removing the tension on the cables and actuating the mechanism in the rear wheels back to its previous mode. For example, rotating the handlebar actuator may cause the rear wheels to transition to the drift mode, whereas by default, the rear wheels may be in the locked mode (however, this is not intended to be limiting and the opposite may also apply).

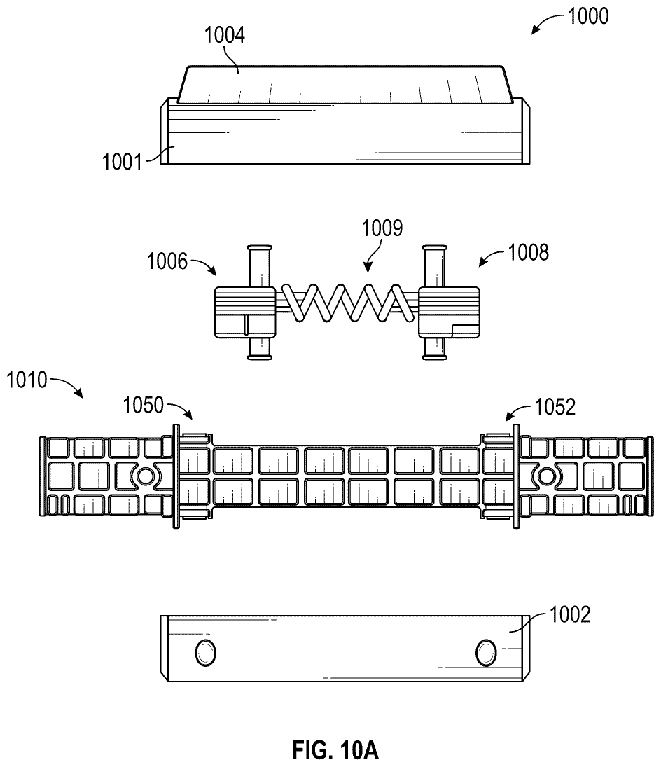

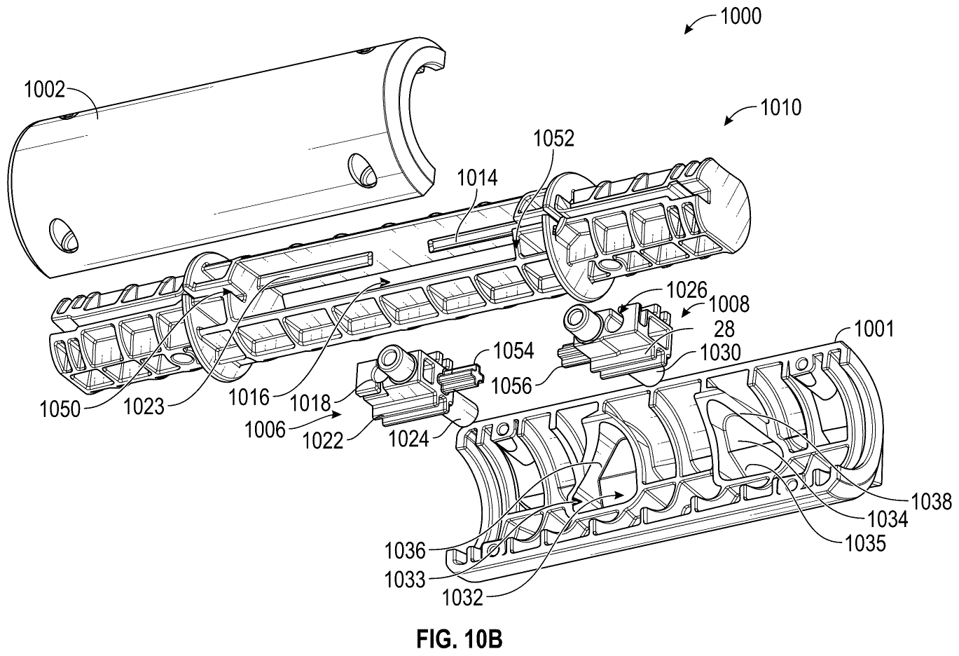

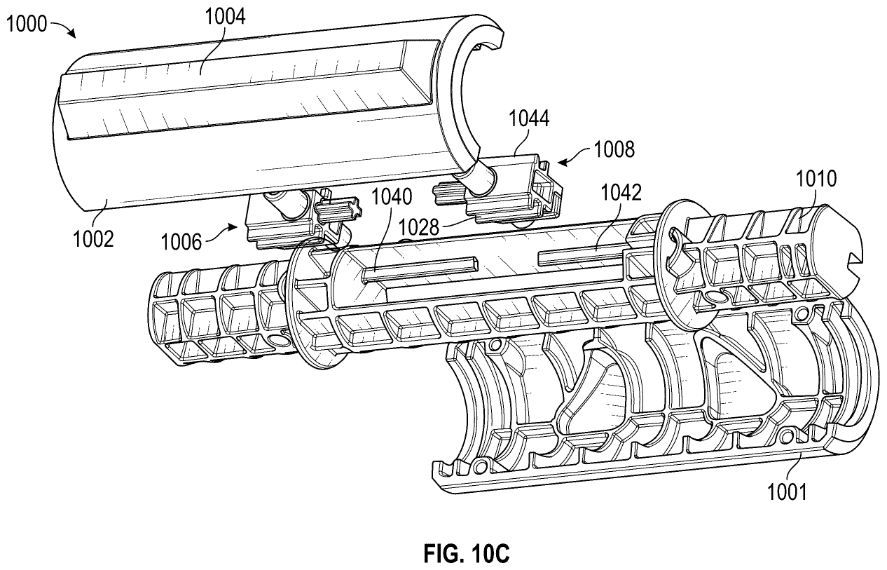

In other embodiments (for example, shown in FIGS. 10A-12D), the handlebar actuator includes the external housing with a protruding tab and an inner core contained within the external housing, but does not include the rotational sleeve. That is, the handlebar actuator may be configured to perform similar functions as the handlebar actuator described with respect to FIGS. 1A-9 without the use of the rotational sleeve. Additionally, the handlebar actuator may include a different configuration for the inner core and may also include different mechanisms for pulling the cables inward to transition the rear wheels between the drift mode and the locked mode (or vice versa).

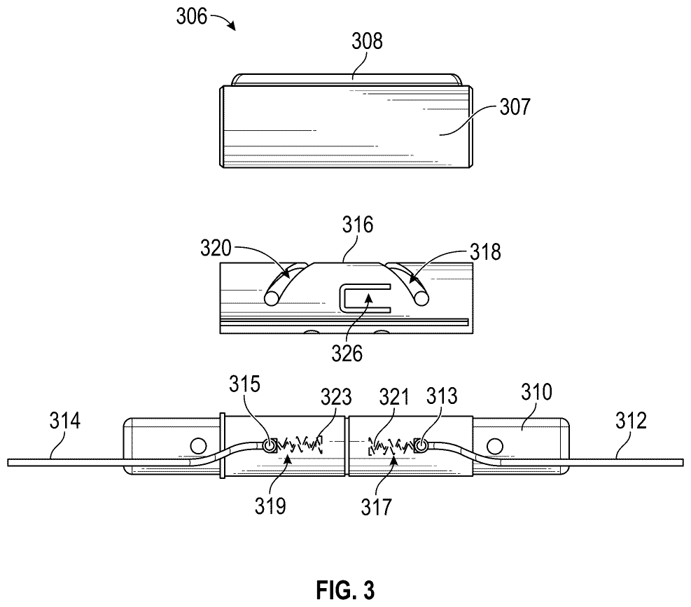

Particularly, the handlebar actuator may include two mechanical sliders. The sliders may operatively engage with both the first portion of the external housing and the inner core (the sliders may also be operatively engaged with the second portion of the external housing as well, or alternatively to the first portion, in some embodiments). As the handlebar actuator is rotated based on a force being provided on the protruding tab, internal structures of the external housing cause the sliders to slide through the inner core and towards a center point within the inner core, similar to how the first pin and the second pin translate towards the center of the inner core as shown in FIG. 3 (although the mechanism used to slide the sliders towards the center of the inner core is different).

The handlebar actuator may also optionally include a spring provided between the first slider and the second slider. The spring may naturally push the first slider and the second slider apart so that the first slider and the second slider naturally rest at a first end and a second end of an opening within the inner core when the handlebar actuator is unrotated. The optional spring may also provide additional outward force against the first slider and the second slider after the handlebar actuator has been rotated such that the first slider and the second slider return to the first end and the second end of the opening in the inner core after the handlebar actuator is released by the user. However, as is described below in further detail, the spring is not necessarily required for the first slider and the second slider to return to the first end and the second end of the opening in the inner core when the handlebar actuator is no longer being engaged by the user.

While reference is made herein to the handlebar actuator specifically being used to transition one or more wheels of the stroller between the drift mode and the locked mode, it should be noted that this application of the handlebar actuator is not intended to be limiting. The actuation of the handlebar actuator may also be used to control other components of the stroller as well.

Examples of variations of these handlebar actuators are described below with respect to the figures.

Turning to the figures, FIG. 1A shows a stroller 100 including a handlebar actuator 106 that is provided on the handlebar 102 of the stroller 100. For example, the handlebar actuator 106 may be centrally located on the handlebar 102, however, the handlebar actuator 106 may also be provided offset from the center of the handlebar 102 as well. Furthermore, although the handlebar actuator 106 is shown as being a single structure, the handlebar actuator 106 may also be separated into multiple distinct structures.

The handlebar actuator 106 includes an external housing 107 that can rotate relative to the handlebar 102 about an axis 109 through the handlebar 102. To provide for ease of rotation, the external housing 107 includes a protruding tab 108. To cause rotation of the handlebar actuator 106 (which may be in either a clockwise or counterclockwise direction relative to the axis 109), a user may provide a downward or upward force on the protruding tab 108 (for example, using one or more of their thumbs).

The hand placement that may be used to perform such actuation is illustrated in FIGS. 1B-1E. Ideally, a user pushes the stroller 100 with both hands positioned on either end of the handlebar, as shown in FIGS. 1B-1C. Advantageously, the improved handlebar actuator described herein allows the user to maintain both hands on either end of the handlebar, while simultaneously actuating the handlebar actuator using one (FIG. 1B) or both (FIG. 1C) thumbs to provide a sufficient force on the protruding tab 108 of the external housing to cause rotation of the handlebar actuator. In contrast, FIGS. 1D-1E show that with the conventional squeeze-based actuator, the user is required to remove at least one of their hands from one end of the handlebar 102 to squeeze the squeeze-based actuator. Therefore, with the conventional handlebar actuator, the user is unable to maintain both hands in the ideal position while pushing the stroller and actuating the handlebar actuator.

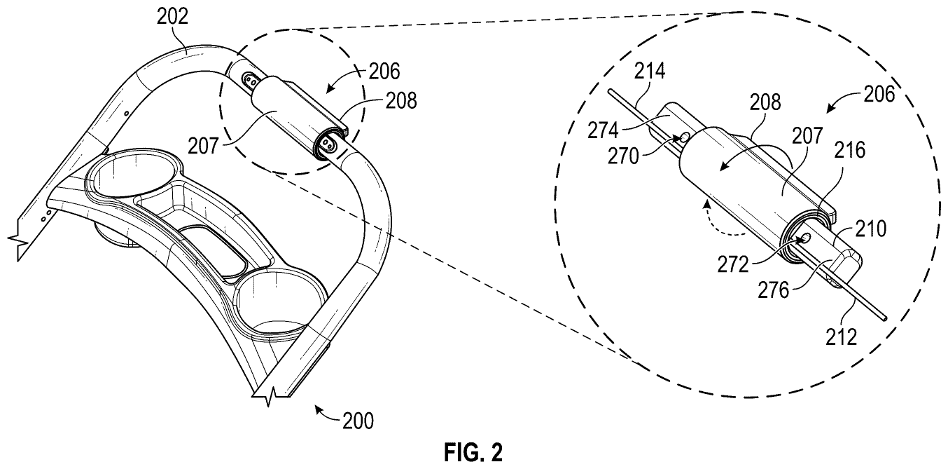

FIG. 2 shows a close-up view of the handlebar actuator 206 (which may be the same as the handlebar actuator 106 of FIG. 1 or any other improved handlebar actuator described herein). The handlebar actuator 206 may include an external housing 207 (including the protruding tab 208), a rotational sleeve 216, and an inner core 210. Also attached to the inner core 210 are two cables (for example, first cable 212 and second cable 214). Each of the cables may also be connected to a mechanism provided at each of the rear wheels of the stroller (not shown in the figure). In this manner, a rotation of the handlebar actuator 206 causes the cables to be pulled inward toward the center of the inner core 210. This movement of the cables causes a change in the mechanisms of the rear wheels, transitioning the rear wheels from the drift mode in which the wheels can freely rotate about the vertical axis, and the locked mode in which the wheels are unable to rotate freely. An example of a type of mechanism that may be provided at the wheels is shown in FIG. 9.

FIG. 2 also shows that the inner core 210 includes apertures (for example, first aperture 270 and second aperture 272) that are provided on either end of the inner 210 (for example, first end 274 and second end 276, respectively). Although FIG. 2 shows two apertures, any other number of apertures (including a single aperture) may also be provided. The apertures may be provided through the full diameter of the inner core 210 or may only extend partially through the inner core 210. The apertures are configured to receive elements to fix the inner core 210 to the handlebar 202. For example, at least a portion of the handlebar 202 may be hollow such that the first end 274 and the second end 276 of the inner core 210 may be inserted into the interior of the handlebar 202. The handlebar 202 may include apertures that align with the apertures of the inner core 210 when the first end 274 and the second end 276 are inserted into the handlebar 202. When the first end 274 and the second end 276 are inserted into the handlebar 202, fastening elements, such as rivets, screws, bolts, etc. may be inserted into the apertures to secure the inner core 210 to the handlebar 202. Accordingly, the inner core 210 may remain fixed and the rotational sleeve 216 and the external housing 207 may rotate relative to the inner core 210 and the handlebar 202.

FIG. 3 shows an exploded view of the handlebar actuator 306 (which may be the same as handlebar actuators 106, 206, etc.). The exploded view shows the external housing 307, the rotational sleeve 316, and the inner core 310. The inner core 310 includes the first cable 312 and the second cable 314 that are attached to a first pin 313 and a second pin 315, respectively. The first pin 313 and the second pin 315 are held within horizontal slots (for example, horizontal slot 317 and horizontal slot 319, respectively). Also provided within the horizontal slots are springs (first spring 321 and second spring 323) that are affixed to the inner core 310 on one end and to a pin on the other end. For example, the first spring 321 is attached to the first pin 313 and the second spring 323 is attached to the second pin 315. In their resting state (before the handlebar actuator 306 is rotated in either direction), the first spring 321 and the second spring 323 naturally force the first pin 313 and the second pin 315 towards the outer ends of the inner core 310 (as shown in FIG. 3).

The rotational sleeve 316 is provided around the inner core 310. The rotational sleeve 316 includes the features configured to control the movement of the first pin 313 and the second pin 315 within the horizontal slots of the inner core 310 to control the movement of the first cable 312 and the second cable 314. To accomplish this, the rotational sleeve 316 includes a first slot 318 for receiving the first pin 313 and a second slot 320 for receiving the second pin 315. The first slot 318 and the second slot 320 are curved inwards along the rotational sleeve 316 such that the first 313 and the second pin 315 move within the first slot 318 and the second slot 320 inwards on the rotational sleeve 316 as the rotational sleeve 316 is rotated (the rotational sleeve 316 is also fixed to the external housing 307 such that the rotation of the external housing causes a rotation of the rotational sleeve 316.

When the rotational sleeve 316 is rotated by a rotation of the external housing 307 (for example, when a user provides a force against the protruding tab 308), the first pin 313 and the second pin 315 move within the first slot 318 and the second slot 320 of the rotational sleeve 316, which causes the first pin 313 and second pin 315 to produce a force against the first spring 321 and second spring 323 and move inwards within the first horizontal slot 319 and the second horizontal slot 317. The movement of the first pin 313 and the second pin 315 within the first horizontal slot 317 and the second horizontal slot 319 causes the first cable 312 and the second cable 314 to be pulled inwards within the horizontal slots towards the center of the inner core 310. When the force is no longer provided against the protruding tab 308, the first spring 321 and the second spring 323 press outwards against the first pin 313 and the second pin 315, causing the first pin and the second pin 315 to return to their original resting positions (as shown in FIG. 3) and cause the handlebar actuator 306 to rotate back to its original position. The first cable 312 and the second cable 314 then also return to their original positions.

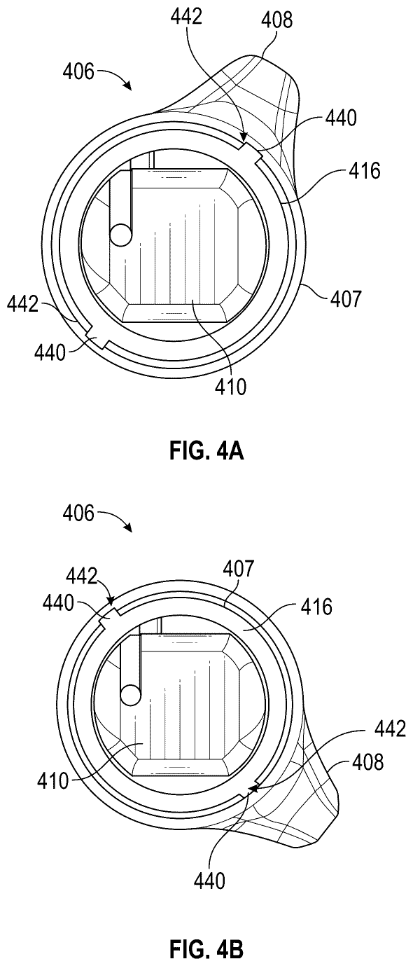

FIG. 4A shows a side view of a handlebar actuator 406 (which may be the same as handlebar actuators 106, 206, 306, or any other handlebar actuator) in a first rotated position. FIG. 4B shows a side view of the handlebar actuator 406 of FIG. 4A in a second rotated position. For example, FIG. 4A may specifically show the handlebar actuator 406 in a natural resting position when a force is not being applied to the protruding tab 408 by a user, and FIG. 4B may show the handlebar actuator 406 in a rotated position after the user applied a downward force on the protruding tab 408.

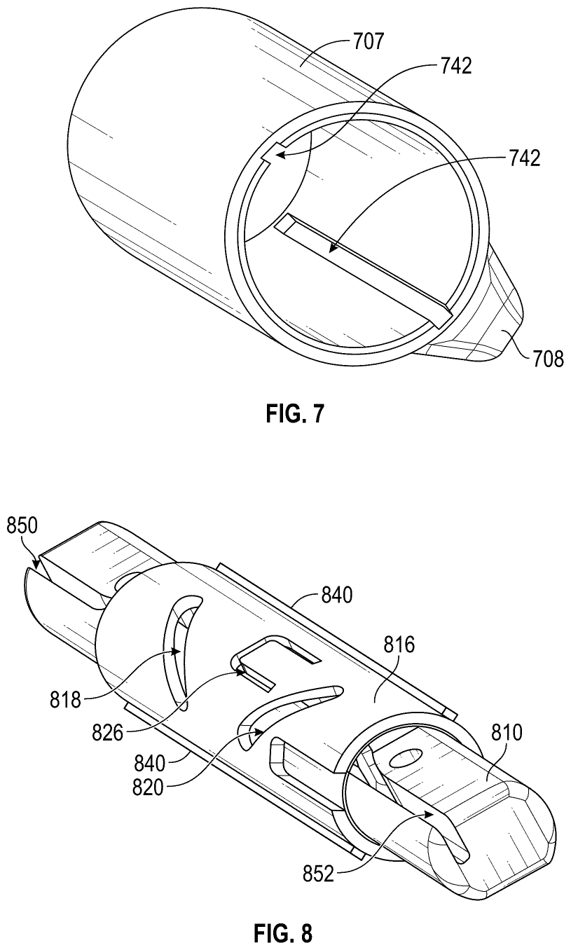

The side views of FIGS. 4A-4B illustrate that the rotational sleeve 416 rotates in conjunction with the external housing 407 relative to the inner core 410. That is, the inner core 410 remains fixed on either end within the handlebar (not shown in FIGS. 4A-4B), and the external housing 407 and the rotational sleeve 416 rotate relative to the fixed inner core 410 and the handlebar. To ensure that the rotational sleeve 416 rotates with the external housing 407, the rotational sleeve 416 and the external housing 407 may include interlocking elements. For example, the rotational sleeve may include protrusions 440 (although only two protrusions are shown in the figures, any other number of protrusions may also be provided at any other intervals around the rotational sleeve 416). The external housing 407 may include corresponding notches 442 for receiving the protrusions 440, thereby locking the rotational sleeve 416 and the external housing 407. These elements are illustrated further in FIGS. 7-8.

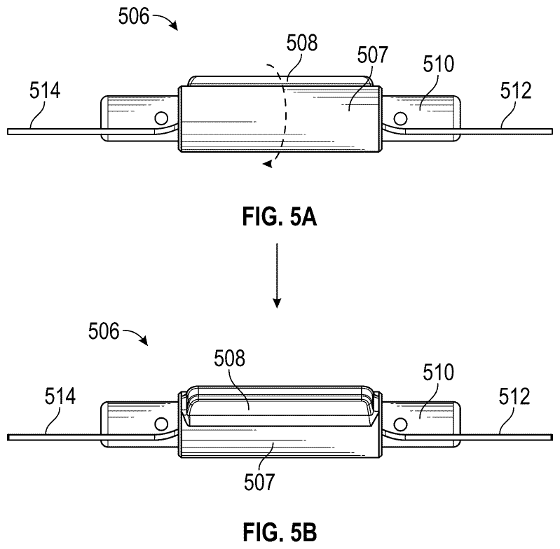

FIG. 5A shows a front view of a handlebar actuator 506 (which may be the same as handlebar actuators 106, 206, 306, 406, or any other handlebar actuator) in the first rotated position. FIG. 5B shows a front view of the handlebar actuator 506 of FIG. 4B in the second rotated position. FIGS. 5A-5B provide another illustration of the manner in which the external housing 507 rotates relative to the inner core 510 by providing a force on the protruding tab 508. As aforementioned, rotation of the external housing 507 causes the first cable 512 and the second cable 514 to pull inwards towards the center of the inner core 510 and extend back outwards from the center of the inner core 510 (as the external housing 507 returns back to its natural resting position).

FIG. 6A shows another front view of a handlebar actuator 606 (without the external housing shown) in a first rotated position. FIG. 6B shows another front view of the handlebar actuator 606 (without the external housing shown) in a second rotated position. The handlebar actuator 606 may be the same as handlebar actuators 106, 206, 306, 406, 506, or any other handlebar actuator.

Particularly, FIGS. 6A-6B illustrate the movement of the first pin 613 and the second pin 615 within the first slot 618 and the second slot 620. As shown in FIG. 3 as well, the first slot 618 and the second slot 620 are curved inwards along the rotational sleeve 616 such that the first 613 and the second pin 615 move within the first slot 618 and the second slot 620 inwards on the rotational sleeve 616 as the rotational sleeve 616 is rotated. For example, FIG. 6A may show the handlebar actuator 606 in a resting position in which no force is being applied to the protruding tab (not shown in FIGS. 6A-6B) and the first pin 613 and the second pin 615 are located at one end of the first slot 618 and the second slot 620.

When the rotational sleeve 616 is rotated by a rotation of the external housing, the first pin 613 and the second pin 615 move within the first slot 618 and the second slot 620. For example, as shown in FIG. 6B, the rotation of the rotational sleeve 616 causes the first pin 613 and the second pin 615 to move within the first slot 618 and the second slot 620 to another end of the first slot 618 and the second slot 620. Although the mechanisms of the inner core 610 provided underneath the rotational sleeve 616 are not visible in FIGS. 6A-6B, as described with respect to FIG. 3, the inner core 610 includes the first cable 612 and the second cable 614 that are attached to the first pin 613 and the second pin 615, respectively. The first pin 613 and the second pin 615 are held within horizontal slots of the inner core 610. Also provided within the horizontal slots are springs that are affixed to the inner core 610 on one end and to a pin on the other end.

When the rotational sleeve 616 is rotated, the first pin 613 and the second pin 615 move within the first slot 618 and the second slot 620, which causes the first pin 613 and second pin 615 to produce a force against the first spring and the second spring (provided on the inner core 610 underneath the rotational sleeve 616 and not visible in FIGS. 6A-6B) and move inwards within the horizontal slots (provided on the inner core 610 underneath the rotational sleeve 616 and not visible in FIGS. 6A-6B) of the inner core 610. This inward movement of the first pin 613 and second pin 615 causes the first cable 612 and the second cable 614 to be pulled inwards towards the center of the inner core 610 (as shown in FIG. 6B). When the force is no longer provided against the protruding tab, the first spring and the second spring press outwards against the first pin 613 and the second pin 615, causing the first pin 613 and the second pin 615 to return to their original resting positions (as shown in FIG. 6A) and cause the handlebar actuator 606 to rotate back to its original position. This causes the first cable 612 and the second cable 614 to extend outwards from the center of the inner core 616 back to their original positions.

FIG. 7 shows a perspective view of an external housing 707 of a handlebar actuator (which may be the same as handlebar actuators 106, 206, 306, 406, 506, 606, or any other handlebar actuator). FIG. 7 provides another view of the interior of the external housing 707 (in which the rotational sleeve and the inner core would be provided) and the notches 742. As aforementioned, the external housing 707 may also include any other number of notches 742 provided at various intervals (or a single notch). Additionally, rather than the notches 742 being provided on the external housing 707 and the protrusions being provided on the rotational sleeve, the notches 742 may be provided on the rotational sleeve and the protrusions may be provided on the interior of the external housing 707. Further, the external housing 707 and the rotational sleeve may be interlocked using any other type of mechanism (e.g., fasteners, adhesives, etc.).

FIG. 8 shows a perspective view of a rotational sleeve 816 and inner core 810 of a handlebar actuator (which may be the same as handlebar actuators 106, 206, 306, 406, 506, 606, or any other handlebar actuator). FIG. 8 shows another view of the rotational sleeve 816 illustrating all of the first slot 818 and the second slot 820 of the rotational sleeve 816. FIG. 8 also shows the protrusions 840 of the rotational sleeve 816 that are received by the notches of the external housing. FIG. 8 also shows first slot 850 and second slot 852 provided on the inner core 810. The first cable and the second cable (not shown in FIG. 8) may be routed through the first slot 850 and the second slot 852.

FIG. 9 shows an exemplary wheel locking mechanism for a wheel 960 of a stroller 900 (which may be the same as stroller 100 of FIG. 1). Particularly, FIG. 9 shows a structure 966 of the wheel 960 that allows for the rotation of the wheel 960 about a vertical axis 968. To allow the wheel 960 to transition between the drift mode in which the wheel 960 is able to freely rotate about the vertical axis 968 and the locked mode when the wheel 960 is unable to freely rotate, a pin 962 may be provided within an aperture 964 of the structure 966. The pin 962 is also attached to a cable (for example, shown as cable 912, which may be the same as cables 212, 312, 412, 512, 612, etc.). Therefore, when the cable 912 is pulled inward based on a rotation of the handlebar actuator relative to the handlebar, the cable 912 is pulled upwards, pulling the pin 962 out of the aperture 964. With the pin 962 out of the aperture 964, the structure 966 is no longer prevented from freely rotating, placing the stroller 900 in the drift mode.

Although FIG. 9 only shows an exemplary mechanism for one wheel 960 of the stroller 900, a similar mechanism may also be found in any other number of wheels that may be actuated by the handlebar actuator. For example, in some embodiments, the handlebar actuator may be used to transition both of the rear wheels between the drift mode and the locked mode. In other embodiments, the handlebar actuator may be used to transition any other number of wheels between the drift mode and the locked mode. Further, multiple wheels may be transitioned simultaneously using the handlebar actuator or different wheels may be individually transitioned. For example, the handlebar actuator may include multiple segments that are independently rotatable relative to one another such that individual segments may be rotated to transition different wheels.

Additionally, the mechanism by which the wheels 960 are transitioned from the drift mode to the locked mode and vice versa is merely an exemplary mechanism and any other type of mechanism attached to the cable 912 may also be used. Furthermore, while the handlebar actuator described herein is described as being used to actuate a mechanism of wheel of the stroller, the handlebar actuator may also be used to actuate any other mechanism of the stroller as well (as one non-limiting example, the handlebar actuator may be used to actuate a mechanism to allow the stroller to be folded).

FIG. 10A shows an exploded front view of another handlebar actuator 1000 that may be used for transitioning the wheels of a stroller (such as any stroller described herein or otherwise) between the drift mode and the locked mode. As indicated above, the rear wheels of the stroller may be transitioned between the drift mode and the locked mode, however, in some embodiments, any other combination of wheels (for example, front wheels, front and rear wheels, etc.) may also be transitioned between the drift mode and the locked mode as well.

The handlebar actuator 1000 includes an external housing comprising a first portion 1001 and a second portion 1002. That is, the external housing may be separated into the two portions to allow for a less difficult plastic injection molding process (although reference is made to plastic injection, the external housing may also be made from any other type of material as well). The first portion 1001 and the second portion 1002 may be combined in any suitable manner, such as an adhesive, one or more fasteners, etc. However, the external housing may also be provided as a single structure as well rather than being separated into the first portion 1001 and the second portion 1002.

Similar to the handlebar actuator(s) shown in FIGS. 1A-9, the external housing of the handlebar actuator 1000 includes a protruding tab 1004. The protruding tab 1004 also allows for the handlebar actuator 1000 to be more easily actuated than the conventional handlebar actuator because the user only needs to apply a small amount of force to the protruding tab to cause the rotation. For example, the user may cause rotation of the handlebar actuator by pressing on the protruding tab 1004 using one or both of their thumbs while maintaining hand positioning on either end of the handlebar. Although FIG. 10A specifically shows the protruding tab 1004 provided on the first portion 1001 of the external housing, this is not intended to be limiting and the protruding tab 1004 may instead be provided on the second portion 1002.

Also similar to the handlebar actuator(s) shown in FIGS. 1A-9, contained within the external housing (when the first portion 1001 and the second portion 1002 are combined) is an inner core 1010. In embodiments, the inner core 1010 may be riveted (or otherwise attached in any other manner) to the tubes of the handle of the stroller (not shown in the figure). The inner core 1010 may serve as a component that bridges the left and right halves of the handle of the stroller such that the handlebar actuator 1000 is integrated into the handle of the stroller. It should be noted that the specific size and/or shape of the inner core 1010 shown in FIG. 10A is merely exemplary and other sizes and/or shapes are also possible (the same may be applicable to other components of the handlebar actuator 1000 as well).

In contrast with the handlebar actuator shown in FIGS. 1A-9, the handlebar actuator 1000 shown in FIGS. 10A-12D may not include the rotational sleeve (for example, rotational sleeves 216, 316, 416, 616, 816, etc.). That is, the handlebar actuator 1000 may be configured to perform similar functions as the handlebar actuator(s) described with respect to FIGS. 1A-9 without the use of the rotational sleeve. Additionally, the handlebar actuator 1000 may include a different configuration for the inner core 1010 and may also include different mechanisms for pulling the cables inward to transition the rear wheels between the drift mode and the locked mode (or vice versa).

In some embodiments, the handlebar actuator 1000 (or any other handlebar actuator described herein) may not necessarily involve a separate inner core. Alternatively, the handle tube itself of the stroller may instead serve as the inner core. For example, one or more slots may be cut directly into the handle tube instead of separating the handle into two components.

Particularly, the handlebar actuator 1000 may include two mechanical sliders (for example, a first slider 1006 and a second slider 1008 or any other number of sliders). As is shown in further detail in subsequent figures, the sliders may be operatively engaged with both the first portion 1001 of the external housing and the inner core 1010 (the sliders may also be operatively engaged with the second portion 1002 of the external housing as well, or alternatively to the first portion 1001, in some embodiments). As the handlebar actuator 1000 is rotated based on a force being provided on the protruding tab 1004, internal structures of the external housing cause the sliders to slide through the inner core 1010 and towards a center point within the inner core 1010, similar to how the first pin 313 and the second pin 315 translate towards the center of the inner core 310 as shown in FIG. 3 (although the mechanism used to slide the sliders towards the center of the inner core 1010 is different). Attached to the sliders may be cables (for example, first cable 1060 is shown as being attached to the first slider 1006 and second cable 1062 is shown as being attached to the second slider 1008). The cables may be attached to the mechanisms at the rear wheels (or any other wheels) that cause the rear wheels to transition between the drift mode and locked mode (and vice versa). A more detailed explanation of the manner by which the external housing causes the sliders to slide during rotation is provided with respect to FIG. 10B.

The handlebar actuator 1000 may also optionally include a spring 1009 between the first slider 1006 and the second slider 1008. The spring 1009 may naturally push the first slider 1006 and the second slider 1008 apart so that the first slider 1006 and the second slider 1008 rest at a first end 1050 and a second end 1052 of an opening (shown in FIGS. 10B-10C) within the inner core 1010 (shown in FIGS. 10B-10C) when the handlebar actuator 1000 is unrotated. The optional spring 1009 produces an additional outward force against the first slider 1006 and the second slider 1008 after the handlebar actuator 1000 has been rotated such that the first slider 1006 and the second slider 1008 return to the first end 1050 and the second end 1052 of the opening in the inner core 1010 after the handlebar actuator 1000 is released by the user. However, as is described below in further detail, the spring 1009 is not necessarily required for the first slider 1006 and the second slider 1008 to return to the first end 1050 and the second end 1052 of the opening in the inner core 1010 when the handlebar actuator 1000 is no longer being engaged by the user.

FIGS. 10B-10C shows an exploded perspective view of the handlebar actuator 1000 of FIG. 10A. FIGS. 10B-10C show the internal mechanisms of the handlebar actuator 1000 in greater detail. Beginning with the sliders, each of the sliders is shown as including at least a cable hole (for example, the first slider 1006 includes cable hole 1018 and the second slider 1008 includes cable hole 1026), rails (for example, the first slider 1006 includes rails 1022 and the second slider includes rails 1028), and a protrusion (for example, first slider 1006 includes protrusion 1024 and second slider 1008 includes protrusion 1030) configured to operatively engage with the interior of the first portion 1001 of the external housing. As indicated above with respect to the inner core 1010, the size and/or shape of the sliders is merely exemplary and other sizes and/or shapes may be possible to achieve the same functionality.

The cable holes are configured to receive and hold the cables that are connected to pins located at the rear wheels of the stroller (not shown in the figure) such that when the sliders move towards the center of the inner core 1010 (for example, the first slider 1006 moves towards the second slider 1008 and vice versa), the sliders pull the cables and cause the actuation of the pins. The cables may also be secured to the sliders in any other suitable manner.

The rails are configured to operatively engage with corresponding rails on the inner core 1010. For example, the rails 1022 of the first slider 1006 are configured to operatively engage with rails 1023 on the inner core 1010 and rails 1028 of the second slider 1008 are configured to operatively engage with rails 1014 on the inner core 1010. Although not visible in the perspective shown in FIG. 10B, each of the sliders may include two sets of rails that operatively engage with two corresponding rails on the inner core 1010. These additional rails are visible in the perspective shown in FIG. 10C. For example, the second slider 1008 is also shown as including rails 1044 provided opposite to rails 1028. Likewise, inner core 1010 may include rail 1042 configured to receive rails 1044 on the second slider 1008 and rail 1040 configured to receive the additional rails (not visible in the figure) on the first slider 1006. Thus, when the sliders are provided within the opening 1016 in the inner core 1010, each of the sliders is operatively engaged with the inner core 1010 on either side of the sliders to facilitate smoother and more effective movement of the sliders with respect to the inner core 1010.

During operation of the handlebar actuator 1000, the rails on each of the sliders slide along the corresponding rails on the inner core 1010 between the ends of the opening 1016 and the center point of the opening 1016. For example, when the handlebar actuator 1000 is rotated, the first slider 1006 would slide along rails 1023 and 1040 from the first end 1050 of the opening 1016 to the center point of the opening 1016. Likewise, the second slider 1008 would slide along rails 1014 and 1042 from the second end 1052 of the opening 1016 to the center point of the opening 1016.

When the handlebar actuator 1000 is in an unrotated position (e.g., a force has not been provided on the protruding tab 1004), the first slider 1006 may naturally rest at the first end 1050 of the opening 1016 of the inner core 1010 and the second slider 1008 may naturally rest at the second end 1052 of the opening 1016 of the inner core 1010. This may be caused by the optional spring 1009 (shown in FIG. 10A that may be provided between the first slider 1006 and the second slider 1008). For example, the spring 1009 may be connected to the first slider 1006 at a second protrusion 1054 on the first slider 1006 and a second protrusion 1056 on the second slider 1008. This may also be caused by the pins located at the wheels of the stroller. As described with respect to FIG. 9, the pins may be connected to springs such that the pins are naturally forced downward when the handlebar actuator 1000 is no longer rotated. Thus, when the handlebar actuator 1000 is released, the springs force the pins back downward and the pins pull the cables, pulling the sliders towards the first end 1050 and the second end 1052 and away from the center point of the opening 1016 of the inner core 1010.

The first protrusions (for example, first protrusion 1024 and first protrusion 1030) of the sliders are configured to operatively engage with corresponding structures on the interior of the first portion 1001 of the external housing (or the interior of the second portion 1002, or both). Particularly, the first protrusion 1024 of the first slider 1006 may be contained within a first internal structure 1032 of the first portion 1001 of the external housing and the first protrusion 1030 of the second slider 1008 may rest within a second internal structure 1034 of the first portion 1001 of the external housing. When the handlebar actuator 1000 is in the unrotated position (for example, a force is not provided against the protruding tab 1004 by a user), the first protrusion 1024 of the first slider 1006 may rest within pocket 1033 of the first internal structure 1032 and the first protrusion 1030 of the second slider 1008 may rest within pocket 1035 of the second internal structure 1034.

When the external housing begins to rotate (for example, based on a force provided to the protruding tab 1004), the first internal structure 1032 and the second internal structure 1034 also begin to rotate relative to the first slider 1006 and the second slider 1008. As the first internal structure 1032 and the second internal structure 1034 rotate relative to the first slider 1006 and the second slider 1008, the first protrusion 1024 of the first slider 1006 slides along ramped surface 1036 of the first internal structure 1032. Likewise, the first protrusion 1030 of the second slider 1008 slides along ramped surface 1038 of the first internal structure 1034. Given that the ramped surface 1036 and the ramped surface 1038 both ramp inward toward a center point of the first portion 1001 of the external housing, the first slider 1006 and the second slider 1008 are forced inwards during the rotation of the external housing. This, in turn, causes the first slider 1006 and the second slider 1008 to slide along the rails of the inner core 1010 towards the center point of the inner core 1010. As the first slider 1006 and the second slider 1008 slide along the rails of the inner core 1010, the first slider 1006 and the second slider 1008 pull on the cables held within the first cable hole 1018 and the second cable hole 1026. As exemplified in FIG. 9, the cables then pull on the pins located at the rear wheels of the stroller, causing the rear wheels to transition between the different modes of operation.

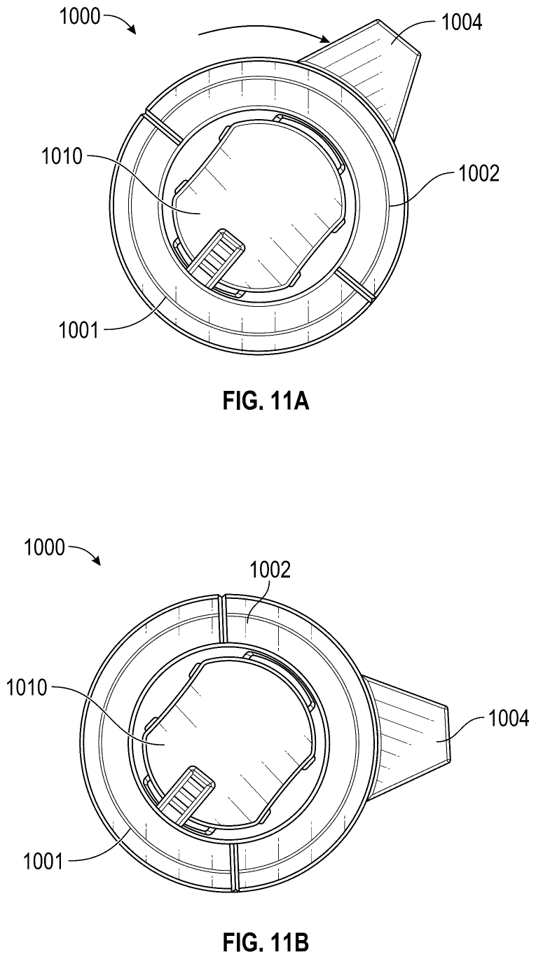

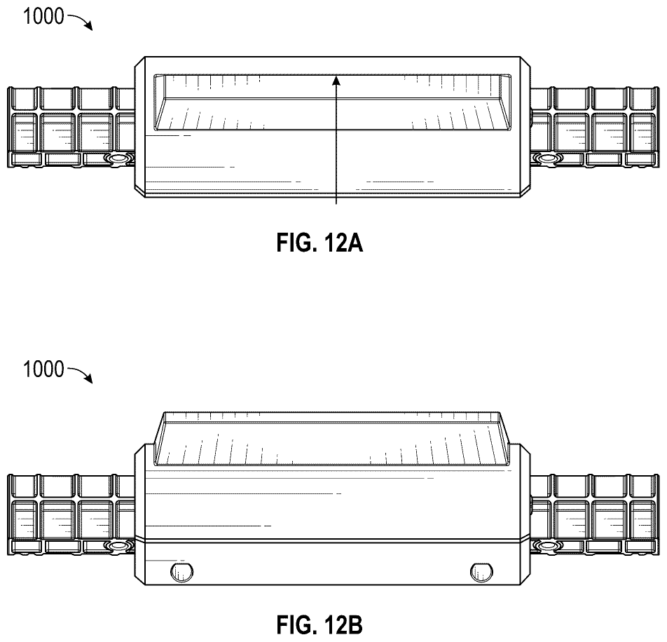

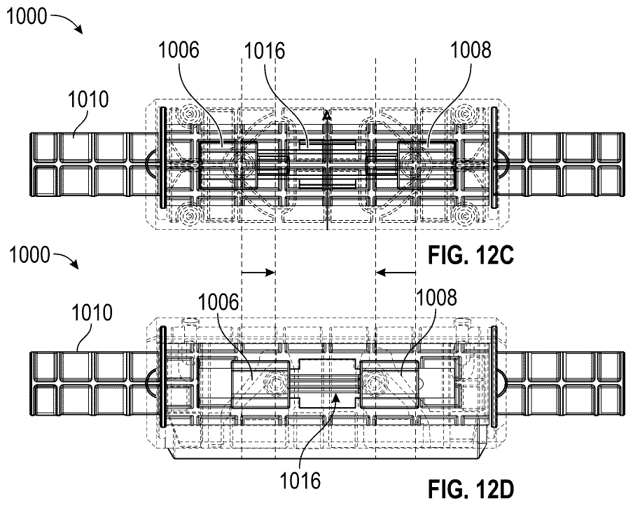

FIGS. 11A-12B illustrate the rotation of the handlebar actuator 1000. FIG. 11A shows a side view of the handlebar actuator 1000 of FIG. 10A in a first rotated position. FIG. 11B shows a side view of the handlebar actuator of FIG. 11A in a second rotated position. FIG. 12A shows a front view of the handlebar actuator 1000 of FIG. 10A in a first rotated position. FIG. 12B shows a front view of the handlebar actuator 1000 of FIG. 10A in a second rotated position. Although FIGS. 11A-12B show that the handlebar actuator 1000 is rotated in a specific direction, this is not intended to be limiting and the handlebar actuator 1000 may also be configured to be rotated in the other direction as well. That is, the handlebar actuator 1000 may be configured to rotate in the counterclockwise or clockwise directions depending on the configuration of the internal mechanisms.

FIG. 12C shows the front view of FIG. 12A with a translucent external housing 1060. For example, the external housing 1060 may include the first portion 1001 and the second portion 1002 shown in FIGS. 10A-12B. However, as indicated above, in some embodiments the external housing 1060 may be a single component rather than two separate portions that are combined. FIG. 12D shows the front view of FIG. 12D with the translucent external housing 1060. Specifically, FIG. 12C corresponds to FIG. 11A and shows the handlebar actuator 1000 in an unrotated position and FIG. 12D corresponds to FIG. 11B and shows the handlebar actuator 1000 in a rotated position.

As described with respect to FIGS. 10B-10C, when the external housing begins to rotate, the structures of the interior of the external housing causes the first slider 1006 and the second slider 1008 to slide along the rails of the inner core 1010 towards the center point of the inner core 1010. As the first slider 1006 and the second slider 1008 slide along the rails of the inner core 1010, the first slider 1006 and the second slider 1008 pull on the cables held within the first cable hole 1018 and the second cable hole 1026.

As indicated above, the pins provided at the rear wheels of the stroller may be spring-loaded. Accordingly, when the user releases the protruding tab 1004, the springs push the pins back downward, pulling on the cables attached to the first slider 1006 and the second slider 1008. The pins pulling the cables back downward causes the cables to pull against the first slider 1006 and the second slider 1008, pulling the first slider 1006 and the second slider 1008 back outward toward the first end and the second end of the opening 1016 of the inner core 1010. As shown in FIG. 10A, in some embodiments, a spring may also be provided between the first slider 1006 and the second slider 1008. This optional spring may provide another force that pushes the first slider 1006 and the second slider 1008 toward the first end and the second end of the opening 1016 of the inner core 1010 when an opposing force caused by the rotation of the external housing no longer exists.

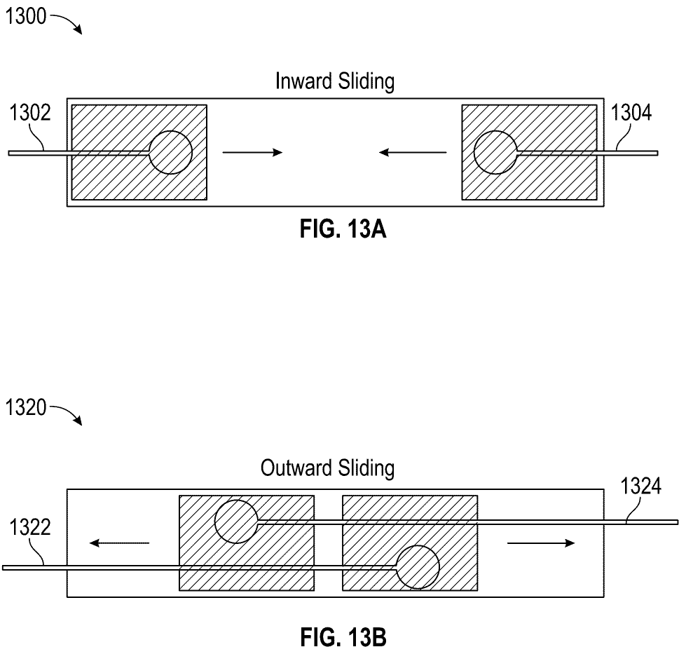

FIGS. 13A-13B show exemplary cable configurations. Particularly, reference is made herein to the transitioning of the stroller from the drift mode to the locked mode (and vice versa) by pulling the cables inward. For example, FIG. 13A shows the first cable 1302 and second cable 1305 being pulled inward to actuate the mechanism that causes the stroller to transition between the modes (for example, the pin 962 shown in FIG. 9). However, this is merely one exemplary manner by which the cables may be manipulated to cause the transition between the modes.

FIG. 13B shows another possibility in which the cables are connected to opposite mechanisms and therefore are both pulled outward to cause the transition between the modes. Using the embodiment shown in FIG. 10A as an example, the first cable 1060 may instead be connected to the second slider 1008 and the second cable 1062 may be connected to the first slider (in a similar manner as shown in 13B). Thus, the movement of the first slider 1006 inward would cause the second cable 1062 to move outward and the movement of the second slider 1008 inward would cause the first cable 1060 to move outward.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A handlebar actuator for a stroller comprising:
an external housing comprising a protruding tab;
an inner core comprising an opening, one or more first rails, and one or more second rails;
a first slider disposed in the opening and configured to translate along the one or more first rails based on a rotation of the external housing; and
a second slider disposed in the opening and configured to translate along the one or more second rails based on the rotation of the external housing.

2. The handlebar actuator of claim 1, wherein the external housing comprises a first structure configured to receive a first protrusion on the first slider and a second structure configured to receive a second protrusion on the second slider, wherein the first structure is configured to cause the first slider to slide along the one or more first rails towards a center of the inner core based on the rotation of the external housing, and wherein the second structure is configured to cause the second slider to slide along the one or more second rails towards the center of the inner core based on the rotation of the external housing.

3. The handlebar actuator of claim 2, wherein the first structure comprises a first ramped surface and the second structure comprises a second ramped surface, wherein the first ramped surface is configured to direct the first slider towards the center of the inner core during the rotation of the external housing and the second ramped surface is configured to direct the second slider towards the center of the inner core during the rotation of the external housing.

4. The handlebar actuator of claim 1, wherein the first slider comprises a first hole configured to receive a first cable and the second slider comprises a second hole configured to receive a second cable.

5. The handlebar actuator of claim 4, wherein the first cable is configured to pull the first slider towards a first end of the inner core, and the second cable is configured to pull the second slider towards a second end of the inner core.

6. The handlebar actuator of claim 1, wherein the first slider comprises one or more third rails and the second slider comprises one or more fourth rails, wherein the one or more first rails of the inner core are configured to receive the one or more third rails of the first slider, and wherein the one or more second rails of the inner core are configured to receive the one or more fourth rails of the second slider.

7. The handlebar actuator of claim 1, further comprising a spring that is operatively coupled between the first slider and the second slider, wherein the spring is configured to produce an outward force against both the first slider and the second slider.

8. The handlebar actuator of claim 1, wherein the inner core further comprises a first aperture for receiving a first rivet or first fastener to secure a first end of the inner core to a handlebar of a stroller at the first end and a second aperture at a second end of the inner core for receiving a second rivet or second fastener to secure the second end to the handlebar.

9. A stroller comprising:
a handlebar; and
a handlebar actuator comprising:
an external housing comprising a protruding tab;
an inner core comprising an opening, one or more first rails, and one or more second rails;
a first slider disposed in the opening and configured to translate along the one or more first rails based on a rotation of the external housing; and
a second slider disposed in the opening and configured to translate along the one or more second rails based on the rotation of the external housing.

10. The stroller of claim 9, wherein the external housing comprises a first structure configured to receive a first protrusion on the first slider and a second structure configured to receive a second protrusion on the second slider, wherein the first structure is configured to cause the first slider to slide along the one or more first rails towards a center of the inner core based on the rotation of the external housing, and wherein the second structure is configured to cause the second slider to slide along the one or more second rails towards the center of the inner core based on the rotation of the external housing.

11. The stroller of claim 10, wherein the first structure comprises a first ramped surface and the second structure comprises a second ramped surface, wherein the first ramped surface is configured to direct the first slider towards the center of the inner core during the rotation of the external housing and the second ramped surface is configured to direct the second slider towards the center of the inner core during the rotation of the external housing.

12. The stroller of claim 9, wherein the first slider comprises a first hole configured to receive a first cable and the second slider comprises a second hole configured to receive a second cable.

13. The stroller of claim 12, wherein the first cable is configured to pull the first slider towards a first end of the inner core, and the second cable is configured to pull the second slider towards a second end of the inner core.

14. The stroller of claim 9, wherein the first slider comprises one or more third rails and the second slider comprises one or more fourth rails, wherein the one or more first rails of the inner core are configured to receive the one or more third rails of the first slider, and wherein the one or more second rails of the inner core are configured to receive the one or more fourth rails of the second slider.

15. The stroller of claim 9, further comprising a spring that is operatively coupled between the first slider and the second slider, wherein the spring is configured to produce an outward force against both the first slider and the second slider.

16. The stroller of claim 9, wherein the inner core further comprises a first aperture for receiving a first rivet or first fastener to secure a first end of the inner core to the handlebar at the first end and a second aperture at a second end of the inner core for receiving a second rivet or second fastener to secure the second end to the handlebar.

17. A stroller comprising:
a handlebar;
a first wheel and a second wheel;
a handlebar actuator comprising:
an external housing comprising a protruding tab;
an inner core comprising an opening, one or more first rails, and one or more second rails;
a first slider disposed in the opening and configured to translate along the one or more first rails based on a rotation of the external housing;
a second slider disposed in the opening and configured to translate along the one or more second rails based on the rotation of the external housing; and
a first cable connected to the first slider at a first end and the first wheel at a second end and a second cable connected to the second slider at a first end and the second wheel at a second end,
wherein the external housing is configured to rotate about the inner core based on a force against the protruding tab, wherein rotation of the external housing causes the first cable and second cable to pull inwards on the first slider and the second slider and unlock a first mechanism at the first wheel and a second mechanism at the second wheel to allow the first wheel and second wheel to freely rotate.

18. The stroller of claim 17, wherein the external housing comprises a first structure configured to receive a first protrusion on the first slider and a second structure configured to receive a second protrusion on the second slider, wherein the first structure is configured to cause the first slider to slide along the one or more first rails towards a center of the inner core based on the rotation of the external housing, and wherein the second structure is configured to cause the second slider to slide along the one or more second rails towards the center of the inner core based on the rotation of the external housing.

19. The stroller of claim 18, wherein the first structure comprises a first ramped surface and the second structure comprises a second ramped surface, wherein the first ramped surface is configured to direct the first slider towards the center of the inner core during the rotation of the external housing and the second ramped surface is configured to direct the second slider towards the center of the inner core during the rotation of the external housing.

20. The stroller of claim 17, further comprising a spring that is operatively coupled between the first slider and the second slider, wherein the spring is configured to produce an outward force against both the first slider and the second slider.
